(19) United States
(12) Patent Application Publication
(10) Pub. No.: US 2019/0050557 A1
(43) Pub. Date: Feb. 14, 2019

(54) METHODS AND SYSTEMS FOR MANAGING PASSWORD USAGE IN A SYSTEM FOR SECURE USAGE OF SHARED ACCOUNTS

(71) Applicant: MModal IP LLC, Franklin, TN (US)

(72) Inventors: Jason Martin, Franklin, TN (US); Martin Harper Randall, Durham, NC (US); Lance Mansfield, Seattle, WA (US)

(21) Appl. No.: 16/100,028

(22) Filed: Aug. 9, 2018

Related U.S. Application Data
(60) Provisional application No. 62/544,168, filed on Aug. 11, 2017.
(60) Provisional application No. 62/563,817, filed on Sep. 27, 2017.

(51) Int. Cl. G06F 21/45; H04L 29/06

(52) U.S. Cl. CPC G06F 21/45; G06F 2221/2101; H04L 63/08

(57) ABSTRACT

A method for managing password usage in a system for secure usage of shared accounts includes generating, by a password manager executing on a first computing device, a first credential assigned to a first user, the first credential used for accessing a first user account in an application executing on a second computing device. The method includes transferring, by the password manager, ownership of the first credential from the first user to a second user. The method includes receiving, by the password manager, over a network, a request from the first user to access the first credential. The method includes verifying, by the password manager, ownership of the first credential by the second user. The method includes denying, by the password manager, the request from the first user.

### CROSS-REFERENCE TO RELATED APPLICATIONS

This application claims priority from U.S. Provisional Patent Application No. 62/544,168, filed on Aug. 11, 2017, entitled “Methods and Systems for Managing Password Usage in a System for Secure Usage of Shared Accounts,” and from U.S. Provisional Patent Application No. 62/563,817, filed on Sep. 27, 2017, entitled “Methods and Systems for Managing Password Usage in a System for Secure Usage of Shared Accounts,” each of which is hereby incorporated by reference.

### BACKGROUND

The disclosure relates to managing shared accounts. More particularly, the methods and systems described herein relate to functionality for managing password usage in a system for secure usage of shared accounts.

Conventionally, password managers may be used to store a user's passwords and other credentials for accessing one or accounts. For example, a user may store email user names and passwords, bank credentials, social media credentials and so on. By using a password manager, the user need only remember the set of credentials used to access the password manager in order to gain access to all the credentials she stores for any number of accounts. Some conventional password managers also provide functionality for generating a password on behalf of the user—for example, by generating and storing a more complex password than the user might have been able to generate without assistance, the password manager can provide the user with increased security. Conventional password managers may also provide functionality for sharing passwords. For example, business owners may wish to share credentials for accessing financial accounts (e.g., online accounting software) with each other, as well as with external bookkeepers or accountants.

Shared accounts may have many benefits in terms of workforce management when used by, for example, outsourcing companies for healthcare providers and other types of account providers that typically lack support for federated identity, automated user provisioning, password self-administration, and so on. For example, when an outsourcing company receives authorization to perform work via remote access, the outsourcing company needs to assign access between its employees and its customers, typically on an individual basis; however, establishing remote access accounts may take a month or more, for example, in securing proper security approvals and aligning customer resources. One side effect of this is that if a user is unavailable for a short period of time (e.g., a weeklong business trip or a two-week vacation), it will take too long to establish an account for a replacement worker—work remains undone and both the outsourcing company and its clients are likely to lose money. Another side effect is that if one customer does not have enough work to do to keep an employee of the outsourcing company employed, the employee cannot be assigned to work on another customer's matters, due to the long lead time for establishing an account. Therefore, the use of shared accounts could help mitigate or solve these types of problems in corporate settings.

As another example of a situation in which shared accounts would be desirable, for services which are licensed on a per-account basis, where the account is allowed to be shared between multiple users, more efficient use of licenses may be desirable. Additionally, in social media products in which multiple users may wish to manage a single account (e.g., multiple brand managers updating a company's microblogging account), more efficient password sharing technology may be desirable.

However, there are several drawbacks to sharing passwords using conventional password managers. For example, conventional password sharing systems do not typically provide auditing functionality, so there is no way to track which user was using the credentials to access an account at any time, making administrative tasks more complicated and creating challenges for securing the account against improper usage by someone who had access to shared accounts. In situations where credentials are used to access an account that restricts a number of users allowed to log in at any one time, if a user is unable to log in for a period of time (e.g., due to illness, travel, etc.) the credentials either go unused or the user's credentials are shared with another user—but there is no way of knowing which user did the work. By way of example, if six individuals are allowed to use the shared credentials but no auditing system is in place, there is typically no way to know which of the six individuals took an action at a particular time or date, such as an action requiring follow-up that should be assigned back to that individual or a fraudulent or other improper action that should result in deauthorization of the responsible user. Furthermore, there is no way of ensuring that only one of the two users actually logged in at any point in time, as might be required by the terms of a license. Another drawback to sharing passwords in conventional systems is that as a result of the other drawbacks (lack of activity logging, inability to respond to audit requests, inability to ensure that only one user at a time uses the credentials, and so on), certain accounts prohibit the use of shared passwords. For example, in settings which must comply with the Health Insurance Portability and Accountability Act of 1996 (“HIPAA”), the Sarbanes-Oxley Act, the Gramm-Leach-Bliley Act, Payment Card Industry Data Security Standard, FDSS, the Federal Information Security Management Act, and other legal requirements, restrictions on shared accounts typically render conventional password managers unacceptable.

### BRIEF SUMMARY

In one aspect, a method for managing password usage in a system for secure usage of shared accounts includes generating, by a password manager executing on a first computing device, a first credential assigned to a first user, the first credential used for accessing a first user account in an application executing on a second computing device. The method includes transferring, by the password manager, ownership of the first credential from the first user to a second user. The method includes receiving, by the password manager, over a network, a request from the first user to access the first credential. The method includes verifying, by the password manager, ownership of the first credential by the second user. The method includes denying, by the password manager, the request from the first user.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for managing password usage in a system for secure usage of shared accounts;

FIG. 1B is a diagram depicting one embodiment of a workflow in which a password manager 104 transfers ownership of a credential from a first user to a second user upon receiving an instruction from a third user;

FIG. 1C is a block diagram depicting one embodiment in which the system 100 includes a user interface with which the user may sign in with a particular username;

FIG. 1D is a block diagram depicting one embodiment in which the system 100 includes a user interface with which the user may sign in with a particular username;

FIG. 1E is a block diagram depicting one embodiment in which the system 100 includes a user interface notifying a user to change a password;

FIG. 1F is a block diagram depicting one embodiment in which the system 100 includes a user interface with which the user may begin a password changing process;

FIG. 1G is a block diagram depicting one embodiment in which the system 100 includes a user interface with which the user may change a password;

FIG. 1H is a block diagram depicting one embodiment in which the system 100 includes a user interface with which the user may confirm that a changed password was accepted;

FIG. 1I is a block diagram depicting one embodiment in which the system 100 includes a user interface with which the user may confirm that authentication to a user account;

FIG. 1J is a block diagram depicting one embodiment in which the system 100 includes a user interface with which the user may confirm that authentication to a user account and begin to access the account;

FIG. 1K is a screen shot depicting one embodiment of a user interface providing functionality for addressing audit questions and satisfying other security and regulatory requirements;

FIG. 1L is a screen shot depicting one embodiment of a user interface providing functionality for displaying a real name of a user of a proxy ID and a level of confidence of the system 100 in the correlation between the real name of the user and the proxy ID;

FIG. 2 is a flow diagram depicting an embodiment of a method for managing password usage in a system for secure usage of shared accounts; and

FIGS. 3A-3C are block diagrams depicting embodiments of computers useful in connection with the methods and systems described herein.

### DETAILED DESCRIPTION

The methods and systems described herein may provide functionality for managing password usage in a system for secure usage of shared accounts.

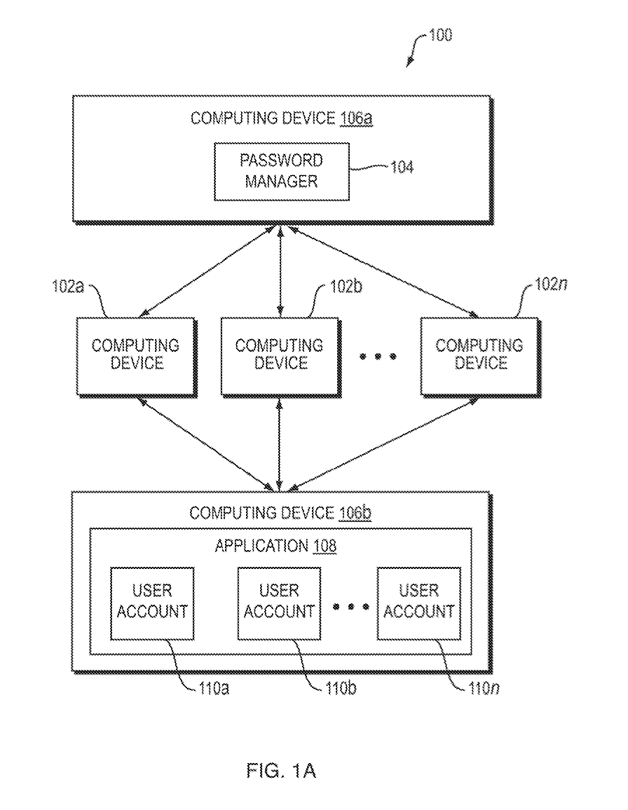

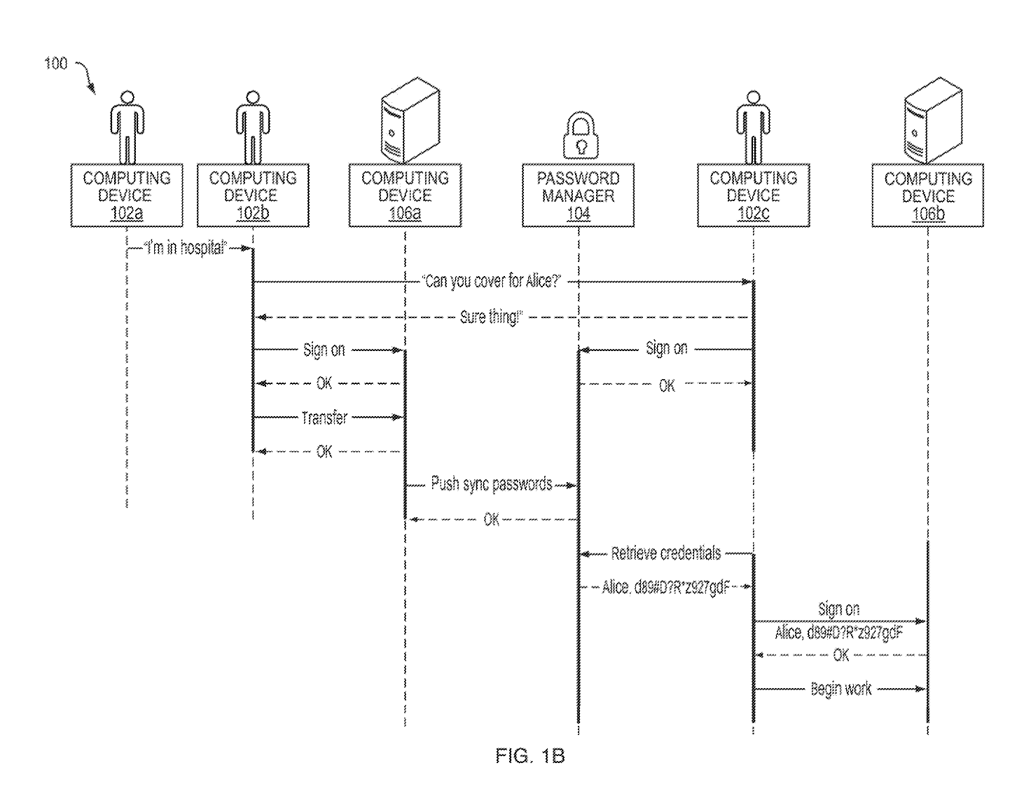

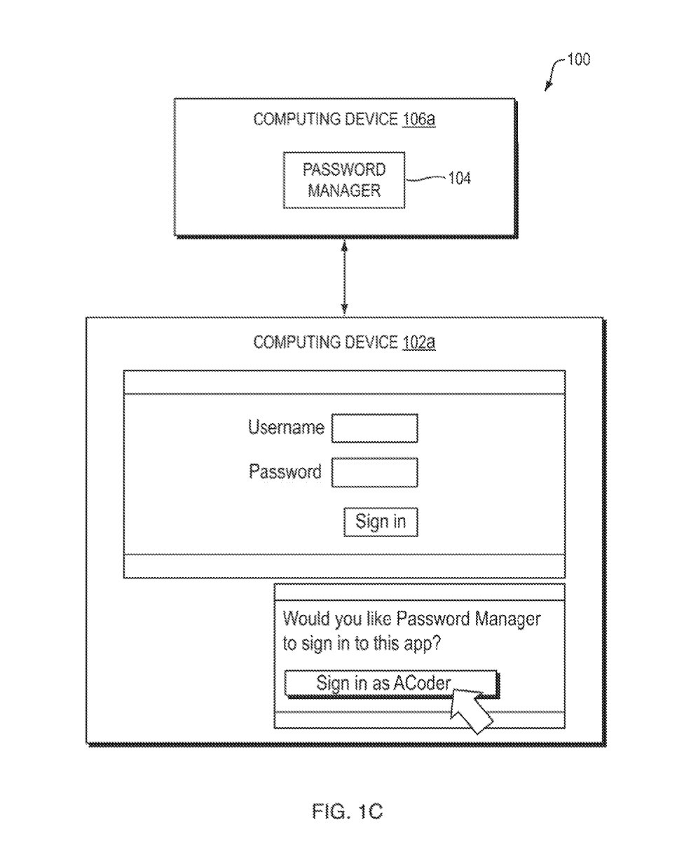

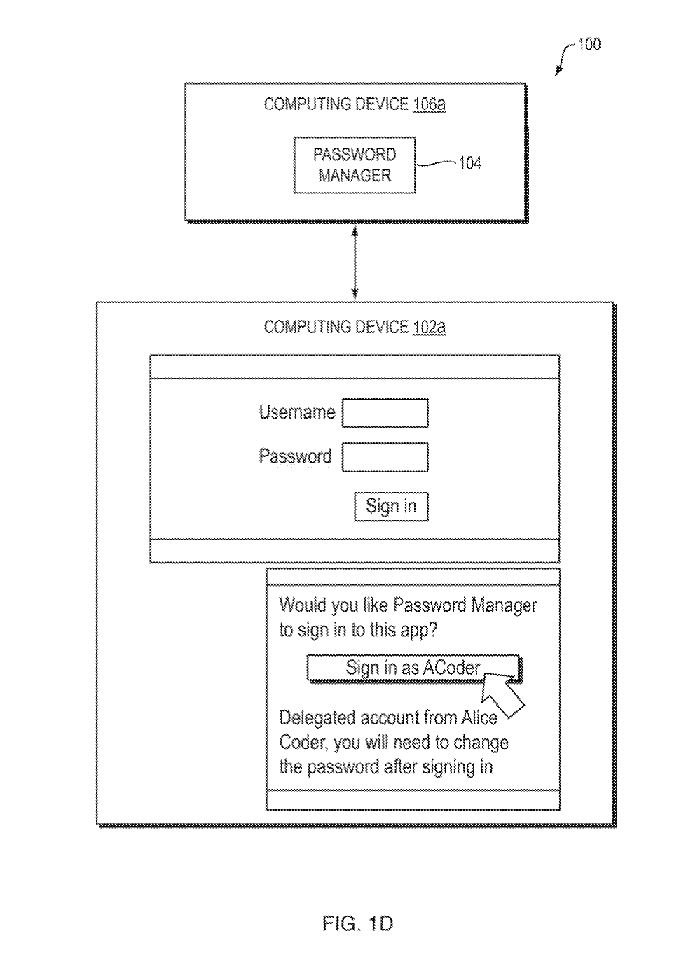

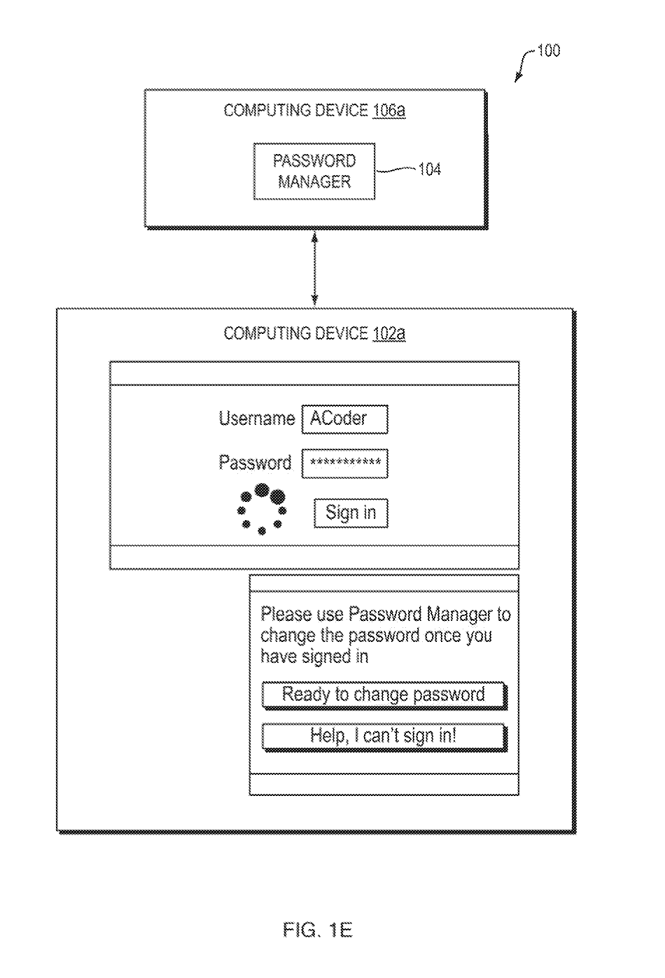

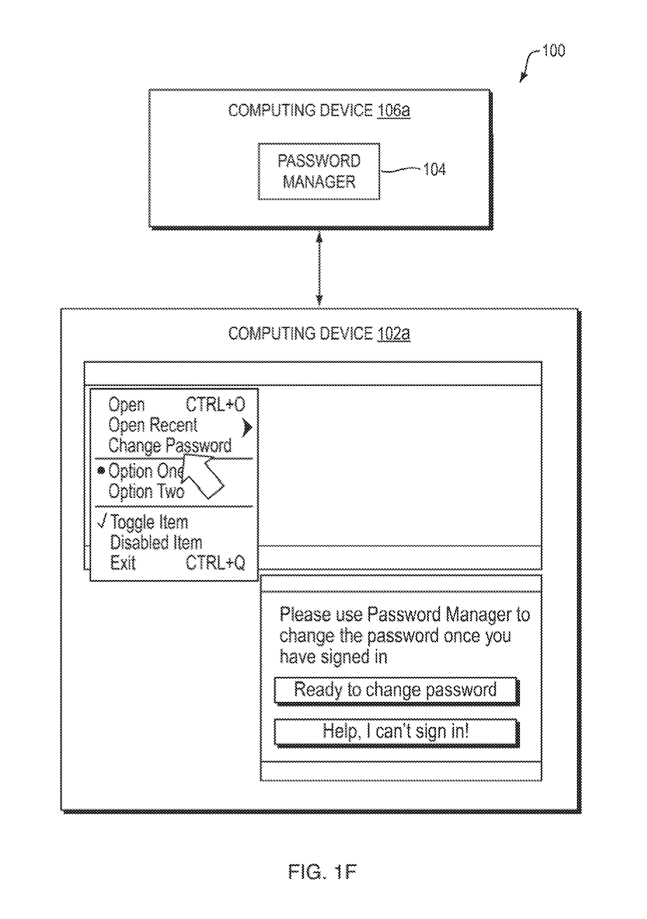

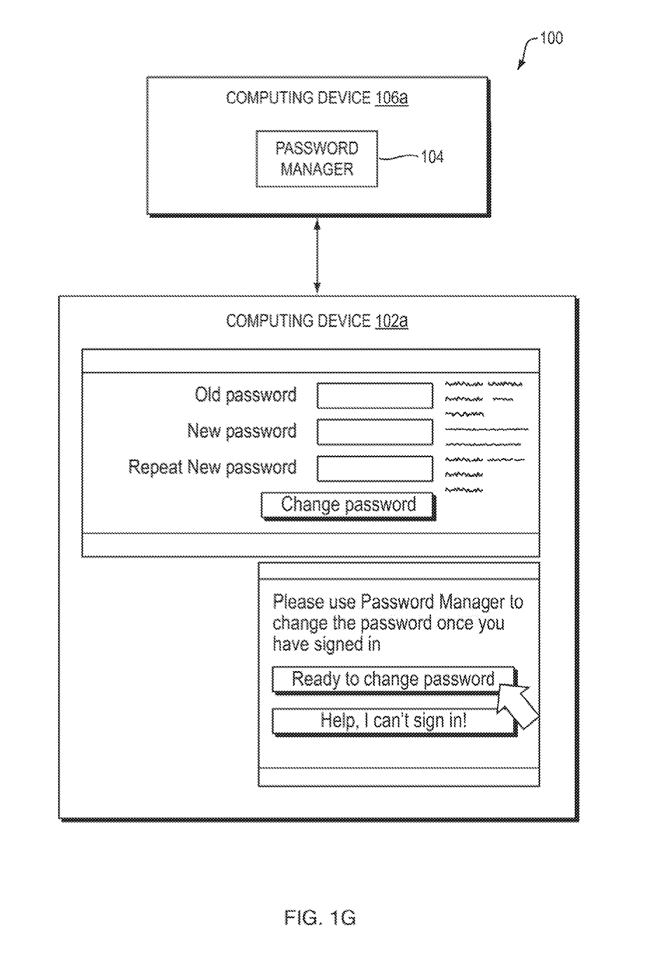

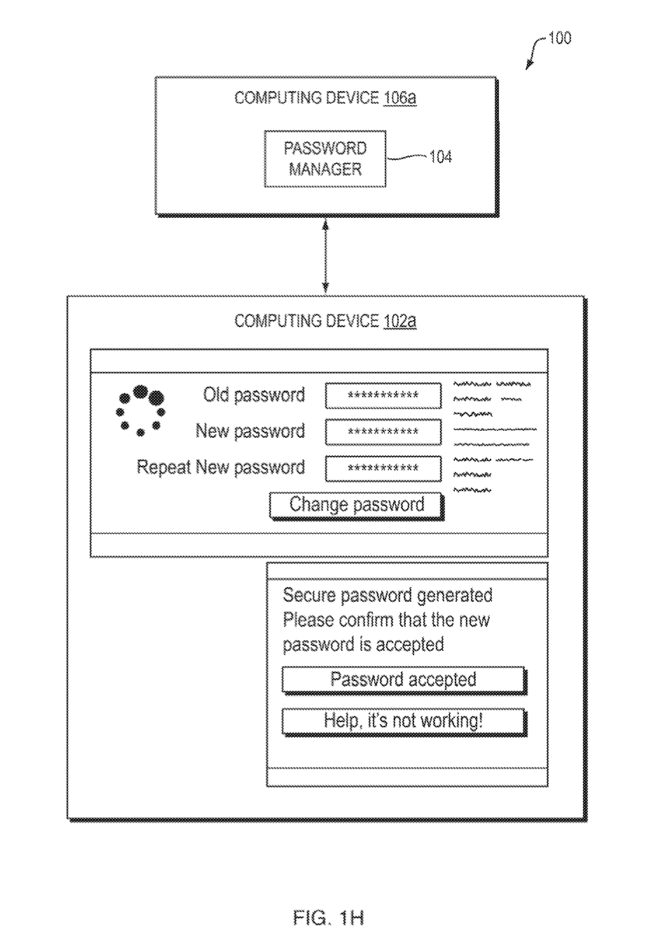

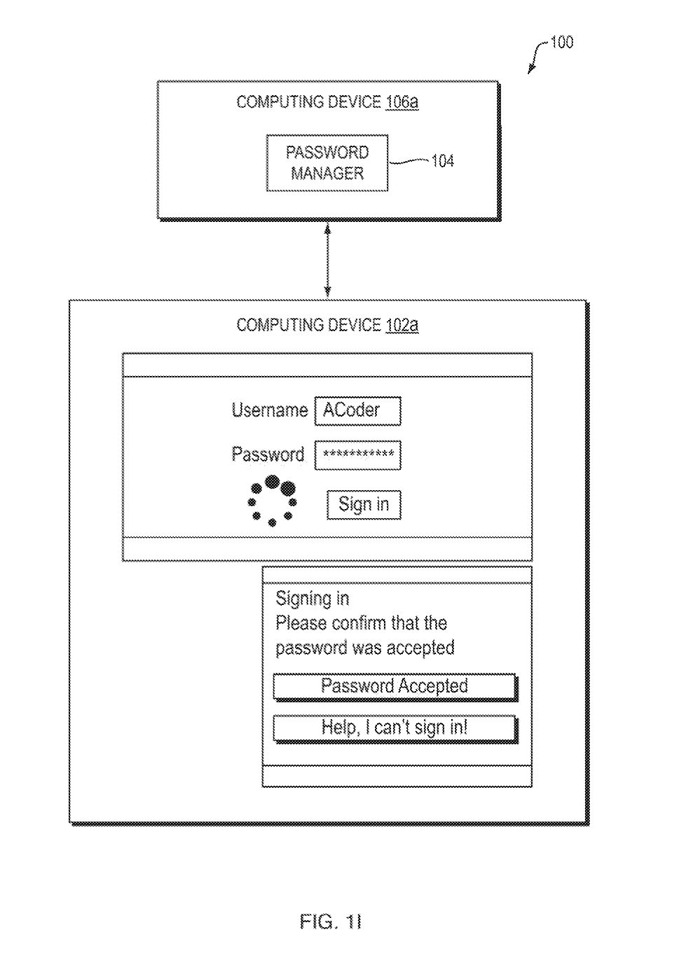

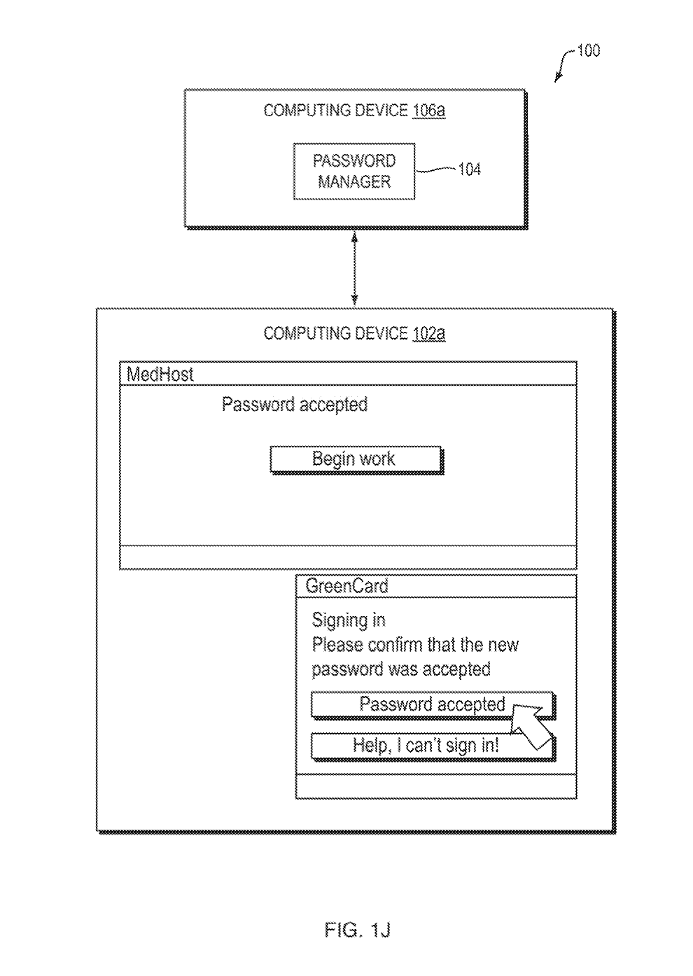

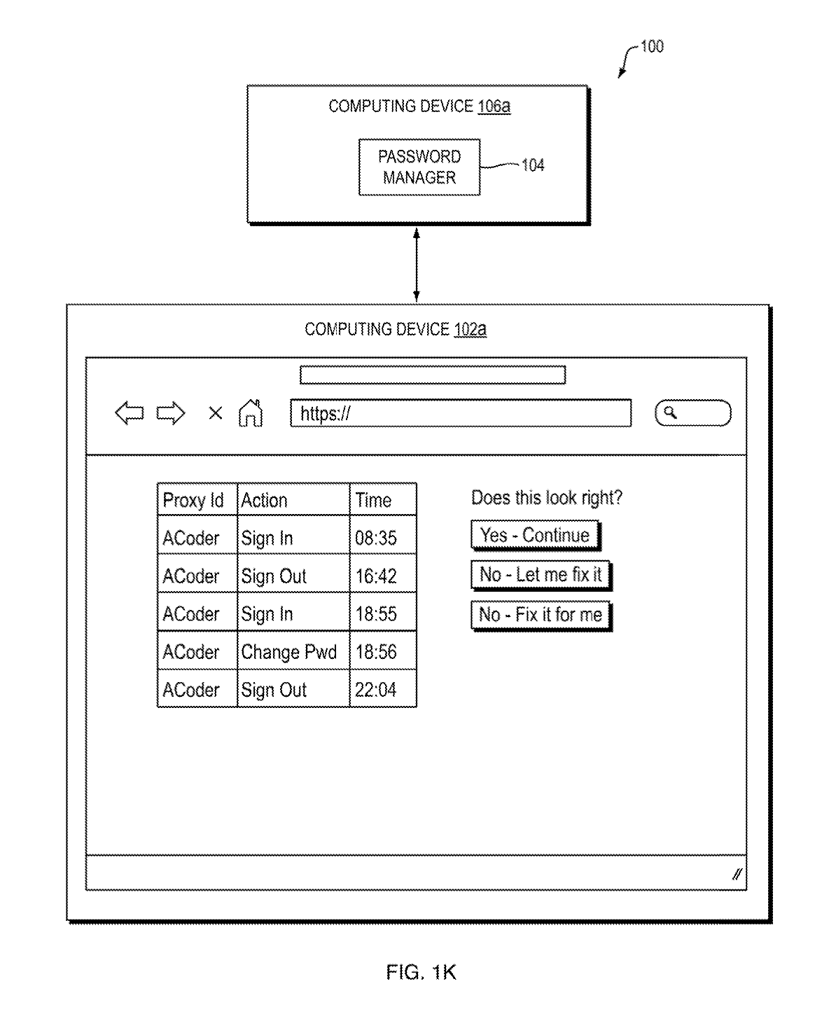

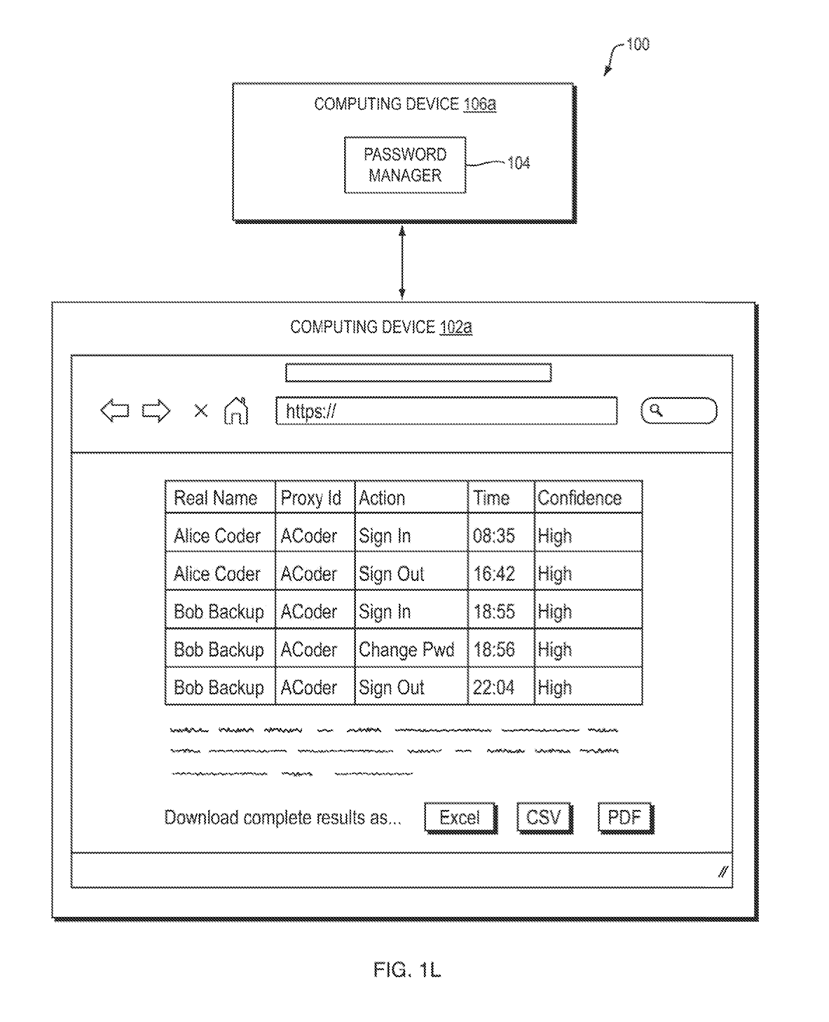

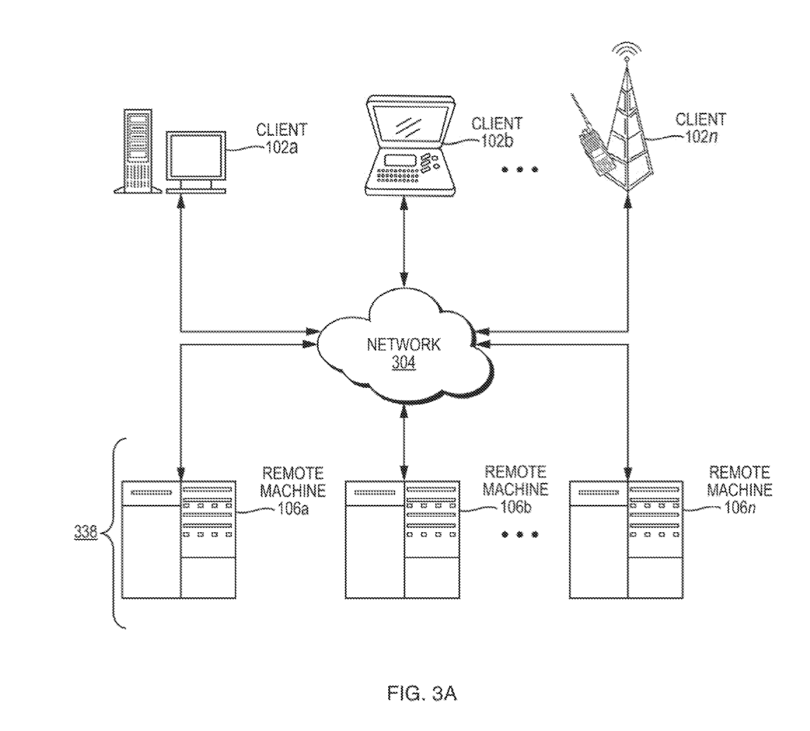

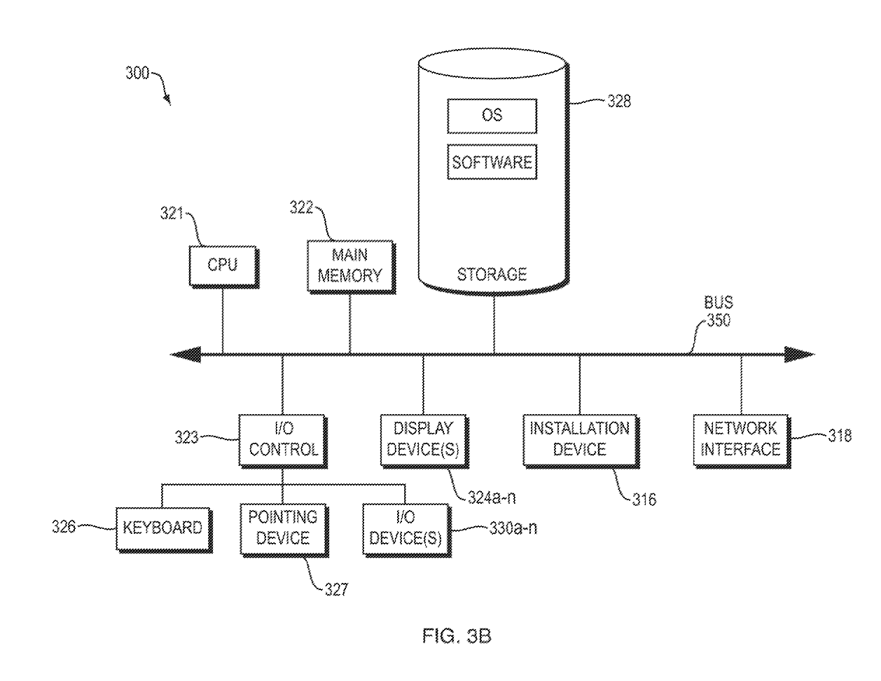

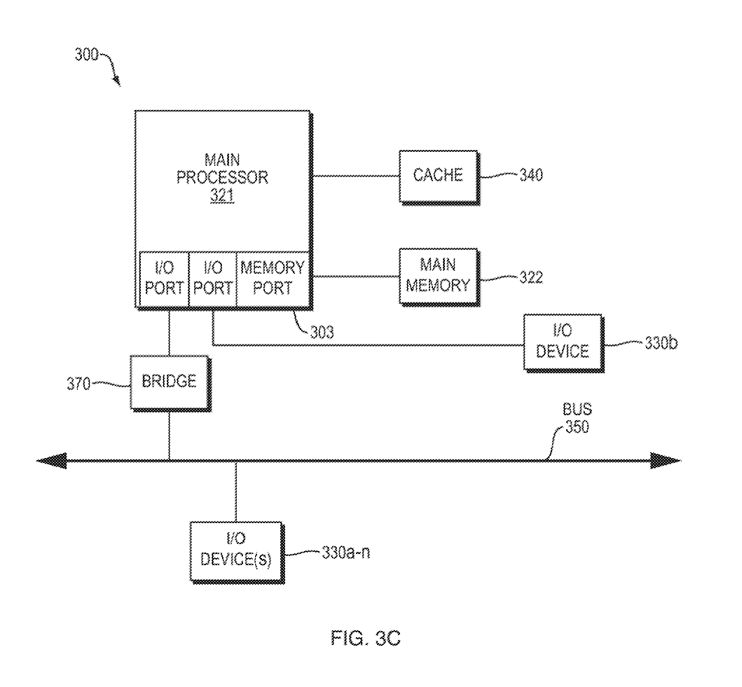

Referring now to FIG. 1A, a block diagram depicts one embodiment of a system for managing password usage in a system for secure usage of shared accounts. In brief overview, the system 100 includes a plurality of computing devices 106, a plurality of computing devices 102a-n, a password manager 104, an application 108, and a plurality of user accounts 110a-n. The computing devices 102 and 106 may be a modified type or form of computing device (as described in greater detail below in connection with FIGS. 3A-C) that has been modified to execute instructions for providing the functionality described herein, resulting in a new type of computing device that provides a technical solution to a problem rooted in computer network technology. As will be understood by those of ordinary skill in the art, the computing devices 102 and 106 may provide access to one or more virtualized environments (e.g., virtual desktops and/or virtualized applications) to one or more remote users. The client device 102 may execute a client-side application in communication with the computing device 106a. In some embodiments, a third-party entity owns, manages, or administers the computing device 106b executing the application 108; the computing device 106a may be, for example and without limitation, owned, managed, or administered by an entity providing an outside workforce (contractors or employees) to its customer the third-party entity and using the password manager 104 to securely manage shared accounts for accessing applications provided by the third-party entity. In some embodiments, the application 108 or a computing device 106b executing the application 108 may, optionally, transmit data to the computing device 106a for back-up.

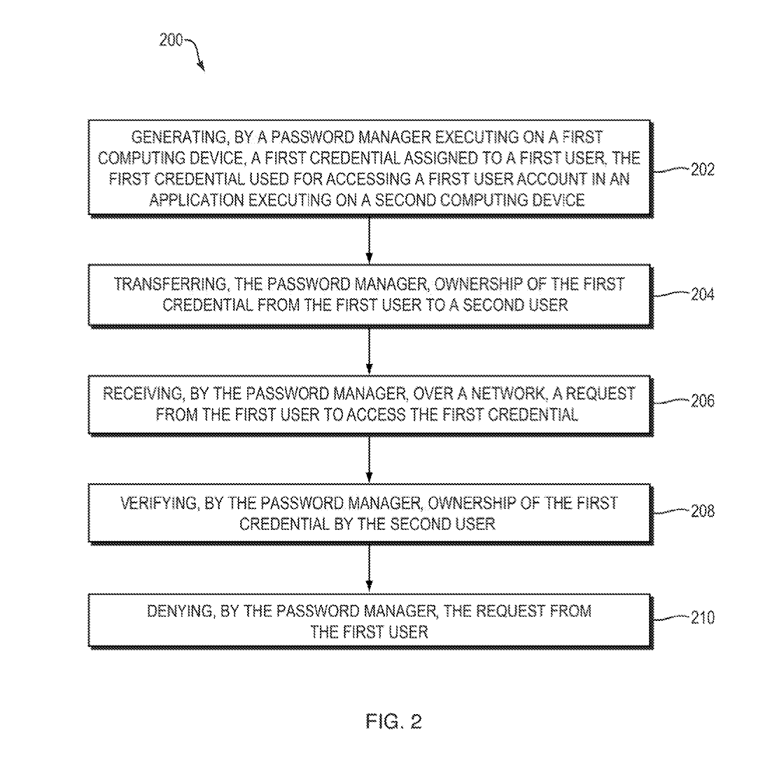

Referring now to FIG. 2, in brief overview, a block diagram depicts one embodiment of a method 200 for managing password usage in a system for secure usage of shared accounts. The method 200 includes generating, by a password manager executing on a first computing device, a first credential assigned to a first user, the first credential used for accessing a first user account in an application executing on a second computing device (202). The method 200 includes transferring, by the password manager, ownership of the first credential from the first user to a second user (204). The method 200 includes receiving, by the password manager, over a network, a request from the first user to access the first credential (206). The method 200 includes verifying, by the password manager, ownership of the first credential by the second user (208). The method 200 includes denying, by the password manager, the request from the first user (210).

Referring now to FIG. 1A and FIG. 2 in greater detail, the method 200 includes generating, by a password manager executing on a first computing device, a first credential assigned to a first user, the first credential used for accessing a first user account in an application executing on a second computing device (202). In some embodiments, the password manager 104 is a software program. In other embodiments, the password manager 104 is a hardware module. In still other embodiments, the password manager 104 executes on the computing device 102, which may be a machine 100 as described below in connection with FIGS. 3A-C. In further embodiments, the password manager 104 may establish secured connections between the computing device 106 and each of the plurality of computing devices 102 (for example, and without limitation, by applying encryption techniques to communications over a network between the computing devices). Although for ease of discussion the password manager 104 is described as a single module, it should be understood that this does not restrict the architecture to a particular implementation. For instance, this module may be encompassed by a single circuit or software function or, alternatively, distributed across a plurality of modules or computing devices. As an example, auditing functionality, encryption functionality, inference generation functionality, and other functionality described below may be provided by subcomponents of the password manager 104 or by separate components in communication with each other and functioning together as the password manager 104. As another example, a conventional password manager may be modified to incorporate an interface or other extension point allowing for implementation of some or all of the features described herein. Optionally, the computing device 106b executing the application 108 may execute a listener application for receiving data from the password manager 104 or the client machines 102.

Credentials may include, without limitation, usernames and passwords and other data associated with a user authorized to access a user account 110. In some embodiments, credentials are stored by the password manager 104 (e.g., on the computing device 106) and not by the client machines 102. In one of these embodiments, the password manager 104 stores the credentials in an encrypted form. Encrypted credentials may be encrypted either symmetrically or asymmetrically, as will be understood by those of ordinary skill in the art. Decryption keys may be available to the password manager 104, to the client machines 102, or to both. The decryption key may also be stored on a USB key or some other portable device carried by the user, to be inserted when credentials require decryption. In another of these embodiments, the credentials are “split” to store them on both server and client, such that both parts of the split are needed to reconstruct the credentials, and each part on its own provides no information on the credentials; this is referred to as “secret sharing,” as will be understood by those of ordinary skill in the art. In other embodiments, credentials are stored by the client machines 102 and not by the password manager 104. In one of these embodiments, an application executing on the client machine 102 and storing one or more passwords also encrypts the stored passwords. In embodiments in which credentials are stored by the client machines 102, the password manager 104 may ensure that the client machine 102 satisfies one or more security requirements. For example, the password manager 104 may forbid the use of removable media with the client machine 102 while the user of the client machine 102 is logged into the password manager 104. As another example, the password manager 104 may require execution of software that restricts a user's ability to copy and paste text (such as credentials) into documents or applications (e.g., email or text messaging applications or other communications applications). Continuing with this example, the password manager 104 may require endpoint management software to be installed, which may then enforce other requirements. Additional requirements imposed may include patch management requirements and malware protection requirements.

In some embodiments, each of the user accounts 110a-n is a software program. In other embodiments, each of the user accounts 110a-n is a hardware module. By entering credentials into the user accounts, users may gain access to the application 108. In some embodiments, the application 108 is a software program. In other embodiments, the application 108 is a hardware module.

The password manager 104 receives, from a third user, an instruction to transfer the ownership of the first credential from the first user to the second user. For example, a manager or administrative user may instruct the password manager to transfer the ownership of the first credential. Alternatively, the password manager 104 may receive the instruction from the first user. As another example, the password manager 104 may receive the instruction from the second user (e.g., because that user is also a manager or administrator, or because in some embodiments users are permitted to issue instructions to transfer credentials; in such a “pull” model, access may be controlled more by reviewing audit logs after the pulls have already occurred). The password manager 104 may include functionality for verifying that the user from which the password manager 104 receives the instruction is authorized to instruct the password manager 104 to transfer ownership of the credential. The password manager 104 may include functionality for verifying that the second user is authorized to receive ownership of the credential; for example, an identifier of the second user may be associated with one or more data structures that include information about a level of authorization of the second user (e.g., a tag that specifies the user has undergone a requisite background check or that the user is in a particular country that is on a list of approved countries for receiving access to sensitive data).

The method 200 includes transferring, by the password manager, ownership of the first credential from the first user to a second user (204). In one embodiment, the password manager 104 receives a request to transfer the ownership of the first credential. In another embodiment, the password manager 104 detects such a transfer after the fact, e.g., based on access to and analysis of a log of IP addresses or machine names associated with usage of a given shared account; if the log is accessible in real-time, this would be sufficient to initiate a password change instruction while the second user is still signed on.

In one embodiment, the password manager 104 instructs the second user to provide a replacement credential. The instruction could come before the second user signs in, after transferring ownership of the first credential or after receiving acknowledgement from the second user of the transfer of ownership, after the second user signs into an account using the transferred credential, at any point between sign-in and sign-out (e.g., if the application is configured to prohibit simultaneous sessions with the same account from two different locations, the password manager 104 may instruct the second user to change the credential at any point before sign-out without compromising security), or after sign-out (either immediately or at any time subsequent to completion of a sign-out process). In such an embodiment, the password manager 104 receives, from the second user, the replacement credential for accessing the first user account (e.g., prior to, accompanying, or subsequent to issuing the instruction to generate the replacement credential). In other embodiments, the password manager 104 automatically generates a second credential replacing the first credential for accessing the first user account. In still other embodiments, the password manager 104 instructs the application 108 (e.g., via an API) to regard the credentials that the second user initially enters as temporary or expired; in one such embodiment, after sign-on, the application 108 will automatically take the second user to a password change interface and the second user cannot continue using the application 108 without changing the password. By requiring generation of a replacement credential (either by the new owner user of the credential or by the password manager 104), the password manager 104 minimizes the likelihood that a previous owner of the credential can reuse the credential (e.g., by having memorized or otherwise stored the old credential). In some embodiments, the system 100 provides one or more user interfaces with which the user may interact with the password manager 104 (either directly or via a client-side application executing on the computing device 102a and in communication with the computing device 106a over a network).

Referring to FIG. 1C, a block diagram depicts one embodiment in which the system 100 includes a user interface with which the user may sign in with a particular username. As depicted in FIG. 1C, the computing device 102a displays a user interface allowing a user to specify that the password manager 104 should sign the user into the application 108 with a particular username (e.g., as shown in FIG. 1C, “ACoder”). Alternatively, in an embodiment in which the application 108 supports an Application Programming Interface (API) for automated sign on, the password manager 104 can use this API to sign the user on without any process of manually navigating through username/password fields.

FIG. 1D is a block diagram depicting one embodiment in which the system 100 includes a user interface with which the user may sign in with a particular username. In the embodiment depicted by FIG. 1D, the system 100 provides an indication that the user is to change the password associated with the account upon signing in to the account.

FIG. 1E is a block diagram depicting one embodiment in which the system 100 includes a user interface notifying a user to change a password. In the embodiment depicted by

FIG. 1E, the system 100 provides a user interface with which the user may indicate readiness to change the password.

FIG. 1F is a block diagram depicting one embodiment in which the system 100 includes a user interface with which the user may begin a password changing process. In the embodiment depicted by FIG. 1F, the system 100 provides a user interface with which the user may request access to functionality for changing a password associated with an account. Alternatively, if the application 108 supports an API for changing the password, the password manager 104 can use the supported API rather than automating the user interface.

FIG. 1G is a block diagram depicting one embodiment in which the system 100 includes a user interface with which the user may change a password. In the embodiment depicted by FIG. 1G, the system 100 provides a user interface with which the user may enter an old password and a new password in order to change the password associated with the account. The entry of the new password can be semi-manual or fully automated, as needed by the application 108.

FIG. 1H is a block diagram depicting one embodiment in which the system 100 includes a user interface with which the user may confirm that a changed password was accepted. FIG. 1I is a block diagram depicting one embodiment in which the system 100 includes a user interface with which the user may confirm that authentication to a user account. FIG. 1J is a block diagram depicting one embodiment in which the system 100 includes a user interface with which the user may confirm that authentication to a user account and begin to access the account.

In some embodiments, the password manager 104 determines that a predetermined period of time has elapsed since the password manager 104 instructed the second user to provide the replacement credential. In one of these embodiments, the password manager 104 generates an alert regarding a failure of the second user to provide the replacement credential and transmits the alert, for example and without limitation, to the second user, to an administrative or management user, or both. In another of these embodiments, the password manager 104 generates the alert when the user signs out. In another of these embodiments, the password manager 104 generates the alert at a time that is the lesser of a predetermined time allowance and a time at which the second user signs out of the application 108. In addition to generating an alert, the password manger 104 may take an action in connection with the account (e.g., locking it out, marking it as expired, or changing the password).

The password manager 104 may enforce mandatory password changes on a predefined schedule (e.g., every month) or upon triggering of an event (e.g., change of status of an employee to inactive or no longer with the organization). The password manager 104 may enforce complexity requirements (e.g., minimum character length, mix of character types, entropy, etc.).

The password manager 104 may enforce mandatory successful sign-ons based on a schedule, or based on time unused. For example, if a shared account is configured to be automatically terminated if it is left unused for more than 90 days, by notifying the currently assigned user to sign on to such accounts after, e.g., 75 days, the password manager 104 keeps the account active and prevents termination or other consequences for failure to log in. For example, if the currently assigned user doesn't respond in 5 days (or other predetermined period), the credentials can automatically be transferred to their manager or an administrative user, who can take the same steps; for instance, if the assigned user is on leave, the system provides functionality to keep the account non-terminated until their return.

Upon signing on to password manager, or periodically throughout a period of usage (e.g., a day, work session, or other period), the user may be notified of any mandatory password changes that they have yet to complete. The user can also indicate if he is unable to complete a mandatory password change (e.g., because they no longer have relevant software installed.

Referring now to FIG. 1B, a diagram depicts one embodiment of a workflow in which a password manager 104 transfers ownership of a credential from a first user to a second user upon receiving an instruction from a third user. As depicted in FIG. 1B, a first user at a computing device 102a indicates to a third user at computing device 102b that the first user is unable to work. The third user determines that a second user at computing device 102c is available for work in place of the first user. The third user accesses the computing device 106a and instructs the password manager 104 to transfer ownership of the credential from the first user to the second user; the password manager 104 does so. In embodiments in which an application 108 (or an entity providing access to such an application) requires multiple credentials to complete a task (e.g., credentials to virtual desktop, electronic health records, electronic mail, and others) the third user could assign all such credentials in a group. When the second user accesses the password manager 104 (e.g., by executing a client-side application from the computing device 102c, establishing a connection (potentially a secure connection) to the computing device 106, and authenticating herself), the computing device 102c retrieves the credentials from the password manager 104; the second user may use the retrieved credentials to access an application 108 provided by the computing device 106b after authenticating and signing in to a user account 110. In some embodiments, a client-side application communicates with the computing device 106, in contrast with traditional password managers that typically only decrypt a locally-stored credential using a user-provided master key without communicating with another computing device.

Referring back to FIGS. 1A and 2, the method 200 includes receiving, by the password manager, over a network, a request from the first user to access the first credential (206). In some embodiments, the password manager 104 may apply additional security checks that are not implemented by the computing device 106b; for example, the password manager 104 may require two-factor authentication, submission of a webcam photo of the user (e.g., which is time-stamped and/or provides an indication of liveness), submission of a signature by the user, or satisfaction of other criteria for authentication and/or authorization.

The method 200 includes verifying, by the password manager, ownership of the first credential by the second user (208). The method 200 includes denying, by the password manager, the request from the first user (210). Transfer of ownership of a credential involves not merely the transfer of the text of, for example a username and password, for sharing with a second user, but of the right to access the credential while the second user owns the credential—unlike conventional systems for sharing passwords in which a plurality of users have access to a password and may each use the password to authenticate with and log into an account, the password manager 104 denies the first user access to the credentials (and thus to the user account 108) while the second user has ownership of the credential, whether or not the second user is logged in to the user account 108.

The second user may access the credential after the password manager 104 transferred ownership of the credential to the second user. In some embodiments, the second user has a user account with the password manager 104 (e.g., separate from the credentials used to access the user account 110) and authenticates herself with the password manager 104 in order to access the credential. An entity providing access to the application 108 may specify one or more features of the user account (e.g., to ensure compatibility with existing systems of the entity). In one of these embodiments, the method 200 includes receiving, by the password manager, from the second user, a second credential used for accessing the password manager and a request for access to the first credential; authenticating, by the password manger, the second user; and transmitting, by the password manager, to the second user, the first credential, based upon the authentication of the second user.

In some embodiments, the password manager 104 implements two-factor authentication and requires the user to satisfy the requirements of the two-factor authentication scheme in order to receive the credential.

In some of these embodiments in which the application 108 requires two-factor authentication, the password manager 104 may route a message such as, for example, a message sent via short message service by the application to a second user after access is delegated by the first user to the second user; in such embodiments, the system may require that the two users do not share the same phone number at which they receive SMS messages for the second factor of the authentication process.

In some embodiments, once the second user has authenticated herself with the password manager 104, the password manager 104 provides a secure autofill functionality. As indicated above, in addition to or instead of secure autofill, in embodiments in which the application 108 provides an API, the password manager 104 may transfer credentials to the application 108 via the API.

In some embodiments, the second user's interactions with the password manager 104 are logged. In one of these embodiments, any and all user interactions with the password manager 104 are logged (including the first user and any administrative users). The password manager 104 may therefore log, in an audit log, an identification of data associated with request for access to the first credential by any user (including, e.g., the first user, the second user, an administrative user, or any other user). Data associated with requests for access may include, without limitation, time of logging, time and date of received requests for access, Internet Protocol (IP) address of user machine 102 from which the password manager 104 receives the request, user identifier associated with the requesting user (e.g., the credential the user has to access the password manager 104, as opposed to the credential the user requests for accessing the application 110), and the result of the request (e.g., whether the password manager 104 granted or denied authorization to access the credential and any supplemental information provided (such as, without limitation, digital signatures, user photographs, etc.). Events that the password manager 104 may track include, without limitation, sign on/off, add credential, use credential, change credential, delete credential, delegate credential, revoke delegation, grant privilege, revoke privilege, create worker, and create customer.

In some embodiments, data associated with requests for access may be used in reports to an entity providing the application 108. For example, a user's IP address and/or machine name may be verified to ensure that the user is accessing the application 108 from an authorized remote address and not attempting to telework from unauthorized location (e.g., an unsecured network at a café). As another example, a user identifier may indicate a level of security clearance associated with the user and this information may be provided to an entity providing the application 108.

The password manager 104 may provide logging functionality that includes the ability to log changes in ownership for one or more credentials. By way of example, the password manager 104 may store in a data structure (e.g., a data structure generated by and stored on the computing device 106 or in a database in communication with the computing device 106) an identification of a credential, an identification of an account accessed through the use of the identified credential, and an identification of a first user that owns the credential; each time the password manager 104 receives a request to transfer ownership of the credential, the password manager 104 may store in the data structure an identification of the requesting user, an identification of a decision to grant or deny the request to transfer ownership of the credential, and an identification of a new owner of the credential if any.

The password manager 104 may provide logging functionality that includes the ability to log specific actions taken by an authorized user. The password manager 104 may include functionality for analyzing one or more logs and generating a description of a user activity based upon the analysis (e.g., by executing an inference engine (not shown) with access to a log database (not shown) and capable of analyzing contents of at least one log to generate an inference). For example, the password manager 104 may receive a first notification that a user has successfully accessed a user account 110 to interact with an application 108 at a first time and a second notification that the user has stopped accessing the application 108 at a second time; from this the password manager 104 may determine that between the first time and the second time, the user was working in the application 108 for that period of time (e.g., if the user logged in to an application 108 at a first time and then logged out of the application 108 at a second time that is two hours later than the first time, the password manager 104 may determine that the user worked for two hours in the application 108. Continuing with this example, such an inference may be checked against other systems (e.g., a time entry application or other time-keeping records). In one embodiment, the password manager 104 receives logs of user data from the user account 110 to make such inferences. In another embodiment, a client-side application executing on a user computing device 102 transmits to the computing device 106a an identification of a type of user activity (e.g., without limitation user log-ins, execution of an application, termination of an application, receiving a web page that indicates the user has logged out of an application 108, receiving a web page that requests a user password to log into a user account 110), or initiating shutdown of the computing device 102).

By logging each authorized user's activities, the password manager 104 may provide improved transparency into account utilization for the entity providing the application 108. By way of example, if password manager 104 generates data structures in which to store information associated with activity by the first user and by the second user, the password manager 104 may then generate and provide productivity reports comparing the users and informing the entity providing the application 108 as to how the account has been utilized over a period of time—for example, indicating the first user had a first level of productivity while the second user had a second level of productivity lower than the first level but better than if no work had been done at all while the first user was out sick. The password manager 104 may also provide improved customer service for the entity providing the application 108. For example, and without limitation, if an individual working for the entity providing the application 108 is accustomed to working for the first user, the password manager 104 enables the second user (or an administrator overseeing the second user) to notify the individual of the staffing change, providing updated contact information as necessary, and assurances that the account usage will continue to satisfy security requirements or other conditions of access specified by the entity. In some embodiments, the password manager 104 may analyze audit log content in order to determine whether to automatically generate and send alerts.

The password manager 104 may receive, from a third user, an instruction to transfer the ownership of the first credential from the second user to the first user. For example, a manger or administrative user may instruct the password manager 104 to transfer the ownership back to the first user. Alternatively, the password manager 104 may receive, from the first user, the instruction to transfer the ownership of the first credential from the second user to the first user. The administrative user may issue the instruction after a period of time (e.g., after the first user returns from vacation), after completion of a task by the second user (e.g., in a situation where the second user has a level of expertise lacking by the first user), or at any other time. The password manager 104 may transfer ownership of the first credential from the second user to the first user, with or without receiving the instruction from the third user (e.g., automatically or upon a lapsing of a predefined period).

In some embodiments, the password manager 104 analyzes a role of a user requesting a transfer of ownership of a credential and a type of account to which the credential grants access. For example, the password manager 104 may be configured to prevent a user from requesting a transfer of ownership of a credential to herself and using her role as a superuser or system administrator to gain personal access to credentials. As another example, the password manager 104 may be configured to prevent a first user from requesting a transfer of ownership of a credential to a second user that has previously transferred ownership to the first user—that is, to prevent two users from conspiring together to work around a restriction on a system administrator or superuser intended to keep the user from granting himself special privileges.

In some embodiments, the password manager 104 provides functionality for satisfying security, regulatory, and other requirements of an entity providing access to the application 108. For example, the password manager 104 may provide functionality for ensuring secure deletion of sensitive data from client machines 102, for deregistration of inactive users, masking passwords from display during log-in processes, inactivity timeouts of users in the login process or while connected to the password manager 104, and the ability to terminate sessions. As another example, the system 100 provides functionality allowing a user at the organization providing the application 108 (e.g., a chief information security officer (CISO)) to receive notifications of sensitive actions (e.g., authentication logs regarding actions to sign in or out of an account or to change a password and action logs regarding actions that are regulated by laws such as HIPAA, including actions to access protected health information), determine the real identities of users who take particular actions (e.g., real name, unique identifiers, session start time (e.g., taken from a sign-in event log from the application 108), session end time (e.g., taken from a sign-out event log from the application 108), and identifier of user who granted authorization to a user retrieving credentials), and to receive and review logs such as authentication logs (including unique identifiers for proxy/shared identities) and action logs, and to answer common audit questions (e.g., regarding who accessed which accounts and regarding access patterns). The system may generate and provide access to logs in a format substantially similar to those provided by the application 108 to further simplify processes for CISO of the application. The system may generate and provide access to logs in a near-identical format, but with annotations indicating extra information only applicable to use of shared accounts with the password manager. The system may generate and provide access to logs via a web application, secure email, ftp server, or other communication mechanism. The logs may include, in some embodiments, data structures storing data identifying a real identity of a user (as described above), a proxy/shared identity of a user (e.g., unique identifier such as user name, shared username, session start time, and session end time), an action taken (e.g., a patient identifier, a chart identifier, a document identifier, a type of action (e.g., view, edit, etc.), a date of an action, a time of an action), and a level of confidence in a reconciliation (e.g., an indicator of a high or low level of confidence in a reconciliation process). The logs can be reviewed to determine any anomalies, such as usage of a shared account that did not proceed via the password manager 104, indicating employee misuse, logging failure, or other factors. Anomalies can be highlighted, or can generate alerts. In some embodiments, the system may provide functionality for analyzing log data to identify data access patterns. In one of these embodiments, such access patterns may be used to determine, by way of example, whether any users have a pattern of accessing large quantities of protected health information that is suspicious (e.g., exceeds a threshold level of access to an extent that suggests misuse of access to data) or whether there is a pattern of any patient data being accessed by many users in a way that is suspicious.

Referring now to FIG. 1K, a screen shot depicts one embodiment of a user interface providing functionality for addressing audit questions and satisfying other security and regulatory requirements. As an example, the user interface may depict logs generated by the password manager 104. In the example depicted by FIG. 1K, the password manager 104 transmits, to the computing device 102a (which may be, for example, used by an administrator or other managerial user), a user interface allowing a user to review actions taken by a user and confirm accuracy or address inaccuracies. For example, in FIG. 1K, the user interface allows the user to review at least one action taken by a user (e.g., sign in, sign out, change password), and a time at which the action was taken. As another example, the user interface may allow a user to import data from an electronic health records system in order to reconcile the imported data with logs generated by the password manger 104.

Referring now to FIG. 1L, a screen shot depicts one embodiment of a user interface providing functionality for displaying a real name of a user of a proxy ID and a level of confidence of the system 100 in the correlation between the real name of the user and the proxy ID. As shown in FIG. 1L, the system 100 may provide functionality for determining whether there are any discrepancies in the data associating a real name of a user with a ProxyID (e.g., an ID associated with a shared password). In one embodiment, if there are no discrepancies, the system 100 may assign an indicator of confidence such as “High” (as shown in FIG. 1L). In another embodiment, if there are any discrepancies, the system 100 may assign an indicator of confidence such as “Low” (as shown in FIG. 1L). Although depicted in FIG. 1L as Boolean values, one of ordinary skill in the art will understand that any confidence indicator may be used, including, for example, a numeric range.

In some embodiments, the system 100 provides functionality for leveraging computer vision technology to monitor the remote desktop to attempt to validate the application(s) being accessed and the proper usage of those application(s). In one of the embodiments, the system 100 provides functionality for implementing machine learning techniques in conjunction with computer vision to identify potentially atypical or concerning usage patterns, or to imperatively validate that correct usage patterns are present. In other embodiments, the system 100 may identify anomalous or atypical conditions via techniques such as logging an internet protocol (IP) address of a remote user's machine, fingerprinting the machine using any of a number of standard methods, fingerprinting the user's web browser, etc., to verify that the source machine of the remote connection matches expected criteria.

The system 100 provides a variety of user interfaces described above that may display information retrieved from data structures and that may dynamically update the data presented to users based on, for example, requests for a type of activity or type of security applicable to the system.

Therefore, the methods and systems described herein provide improved functionality for sharing passwords. Replacement users may use shared credentials when main users are unavailable while the system provides improved security (stronger passwords, transaction logging, and so on), without requiring additional involvement from the entities establishing the shared user accounts.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 3A, 3B, and 3C, block diagrams depict additional detail regarding computing devices that may be modified to execute novel, non-obvious functionality for implementing the methods and systems described above.

Referring now to FIG. 3A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 304.

Although FIG. 3A shows a network 304 between the clients 102 and the remote machines 106, the clients 102 and the remote machines 106 may be on the same network 304. The network 304 can be a local area network (LAN), such as a company Intranet, a metropolitan area network (MAN), or a wide area network (WAN), such as the Internet or the World Wide Web. In some embodiments, there are multiple networks 304 between the clients 102 and the remote machines 106. In one of these embodiments, a network 304′ (not shown) may be a private network and a network 304 may be a public network. In another of these embodiments, a network 304 may be a private network and a network 304′ a public network. In still another embodiment, networks 304 and 304′ may both be private networks. In yet another embodiment, networks 304 and 304′ may both be public networks.

The network 304 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 304 may comprise a wireless link, such as an infrared channel or satellite band. The topology of the network 304 may be a bus, star, or ring network topology. The network 304 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 338. In another of these embodiments, the server farm 338 may be administered as a single entity.

FIGS. 3B and 3C depict block diagrams of a computing device 100 useful for practicing an embodiment of the client 102 or a remote machine 106. As shown in FIGS. 3B and 3C, each computing device 100 includes a central processing unit 321, and a main memory unit 322. As shown in FIG. 3B, a computing device 100 may include a storage device 328, an installation device 316, a network interface 318, an I/O controller 323, display devices 324a-n, a keyboard 326, a pointing device 327, such as a mouse, and one or more other I/O devices 330a-n. The storage device 128 may include, without limitation, an operating system and software. As shown in FIG. 1C, each computing device 100 may also include additional optional elements, such as a memory port 303, a bridge 370, one or more input/output devices 330a-n (generally referred to using reference numeral 330), and a cache memory 340 in communication with the central processing unit 321.

The central processing unit 321 is any logic circuitry that responds to and processes instructions fetched from the main memory unit 322. In many embodiments, the central processing unit 321 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 100 may be based on any of these processors, or any other processor capable of operating as described herein.

Main memory unit 322 may be one or more memory chips capable of storing data and allowing any storage location to be directly accessed by the microprocessor 321. The main memory 322 may be based on any available memory chips capable of operating as described herein. In the embodiment shown in FIG. 3B, the processor 321 communicates with main memory 322 via a system bus 350. FIG. 3C depicts an embodiment of a computing device 100 in which the processor communicates directly with main memory 322 via a memory port 303. FIG. 3C also depicts an embodiment in which the main processor 321 communicates directly with cache memory 340 via a secondary bus, sometimes referred to as a backside bus. In other embodiments, the main processor 321 communicates with cache memory 340 using the system bus 350.

In the embodiment shown in FIG. 3B, the processor 321 communicates with various I/O devices 330 via a local system bus 350. Various buses may be used to connect the central processing unit 321 to any of the I/O devices 330, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 324, the processor 321 may use an Advanced Graphics Port (AGP) to communicate with the display 324. FIG. 3C depicts an embodiment of a computer 100 in which the main processor 321 also communicates directly with an I/O device 330b via, for example, HYPERTRANSPORT, RAPIDIO, or INFINIBAND communications technology.

One or more of a wide variety of I/O devices 330a-n may be present in or connected to the computing device 100, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 323 as shown in FIG. 3B. Furthermore, an I/O device may also provide storage and/or an installation medium 316 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 3B, the computing device 100 may support any suitable installation device 316, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 100 may provide functionality for installing software over a network 304. The computing device 100 may further comprise a storage device, such as one or more hard disk drives or redundant arrays of independent disks, for storing an operating system and other software. Alternatively, the computing device 100 may rely on memory chips for storage instead of hard disks.

Furthermore, the computing device 100 may include a network interface 318 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 318 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In further embodiments, an I/O device 330 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCl/LAMP bus, a FibreChannel bus, or a Serial Attached small computer system interface bus.

A computing device 100 of the sort depicted in FIGS. 3B and 3C typically operates under the control of operating systems, which control scheduling of tasks and access to system resources. The computing device 100 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc., of Raleigh, N.C.; Ubuntu, a freely-available operating system distributed by Canonical Ltd. of London, England; or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments, the computing device 100 is a mobile device, such as a JAVA-enabled cellular telephone/smartphone or personal digital assistant (PDA). The computing device 100 may be a mobile device such as those manufactured, by way of example and without limitation, by Apple Inc. of Cupertino, Calif.; Google/Motorola Div. of Ft. Worth, Tex.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smartphone, POCKET PC, POCKET PC PHONE, or other portable mobile device supporting Microsoft Windows Mobile Software.

In some embodiments, the computing device 100 is a digital audio player. In one of these embodiments, the computing device 100 is a digital audio player such as the Apple IPOD, IPOD TOUCH, IPOD NANO, and IPOD SHUFFLE lines of devices manufactured by Apple Inc. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Google/Motorola line of combination digital audio players and mobile phones. In another of these embodiments, the computing device 100 is a device in the IPHONE smartphone line of devices manufactured by Apple Inc. In still another of these embodiments, the computing device 100 is a device executing the ANDROID open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the IPAD line of devices manufactured by Apple Inc.; the PLAYBOOK manufactured by Research In Motion; the CRUZ line of devices manufactured by Velocity Micro, Inc. of Richmond, Va.; the FOLIO and THRIVE line of devices manufactured by Toshiba America Information Systems, Inc. of Irvine, Calif.; the GALAXY line of devices manufactured by Samsung; the HP SLATE line of devices manufactured by Hewlett-Packard; and the STREAK line of devices manufactured by Dell, Inc. of Round Rock, Tex.

Having described certain embodiments of methods and systems for managing password usage in a system for secure usage of shared accounts, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for managing password usage in a system for secure usage of shared accounts, the method comprising:
generating, by a password manager executing on a first computing device, a first credential assigned to a first user, the first credential used for accessing a first user account in an application executing on a second computing device;
transferring, by the password manager, ownership of the first credential from the first user to a second user;
receiving, by the password manager, over a network, a request from the first user to access the first credential;
verifying, by the password manager, ownership of the first credential by the second user;
denying, by the password manager, the request from the first user.

2. The method of claim 1 further comprising instructing, by the password manager, the second user to provide a replacement credential.

3. The method of claim 2 further comprising receiving, by the password manager, from the second user, a replacement credential for accessing the first user account.

4. The method of claim 1 further comprising replacing, by the password manager, the first credential with a second credential for accessing the first user account.

5. The method of claim 1 further comprising receiving, from a third user, an instruction to transfer the ownership of the first credential from the first user to the second user.

6. The method of claim 1 further comprising receiving, from a third user, an instruction to transfer the ownership of the first credential from the second user to the first user.

7. The method of claim 1 further comprising transferring, by the password manager, ownership of the first credential from the second user to the first user.

8. The method of claim 1 further comprising:
receiving, by the password manager, from the second user, a second credential used for accessing the password manager and a request for access to the first credential;
authenticating, by the password manger, the second user;
transmitting, by the password manager, to the second user, the first credential, based upon the authentication of the second user;

9. The method of claim 1 further comprising logging, by the password manager, in an audit log, an identification of data associated with a request for access to the first credential by the second user.

10. The method of claim 1 further comprising logging, by the password manager, in an audit log, an identification of data associated with a request for access to the first credential by the first user.

11. A computer-readable medium comprising computer-readable instructions tangibly stored on the computer-readable medium, wherein the instructions are executable by at least one processor to perform a method for managing password usage in a system for secure usage of shared accounts, the method comprising:
generating, by a password manager executing on a first computing device, a first credential assigned to a first user, the first credential used for accessing a first user account in an application executing on a second computing device;
transferring, by the password manager, ownership of the first credential from the first user to a second user;
receiving, by the password manager, over a network, a request from the first user to access the first credential;
verifying, by the password manager, ownership of the first credential by the second user;
denying, by the password manager, the request from the first user.

12. The computer-readable medium of claim 11 further comprising computer-readable instructions for instructing, by the password manager, the second user to provide a replacement credential.

13. The computer-readable medium of claim 12 further comprising computer-readable instructions for receiving, by the password manager, from the second user, a replacement credential for accessing the first user account.

14. The computer-readable medium of claim 11 further comprising computer-readable instructions for replacing, by the password manager, the first credential with a second credential for accessing the first user account.

15. The computer-readable medium of claim 11 further comprising computer-readable instructions for receiving, from a third user, an instruction to transfer the ownership of the first credential from the first user to the second user.

16. The computer-readable medium of claim 11 further comprising computer-readable instructions for receiving, from a third user, an instruction to transfer the ownership of the first credential from the second user to the first user.

17. The computer-readable medium of claim 11 further comprising computer-readable instructions for transferring, by the password manager, ownership of the first credential from the second user to the first user.

18. The computer-readable medium of claim 11 further comprising computer-readable instructions for:
receiving, by the password manager, from the second user, a second credential used for accessing the password manager and a request for access to the first credential;
authenticating, by the password manger, the second user;
transmitting, by the password manager, to the second user, the first credential, based upon the authentication of the second user;

19. The computer-readable medium of claim 11 further comprising computer-readable instructions for logging, by the password manager, in an audit log, an identification of data associated with a request for access to the first credential by the second user.

20. The computer-readable medium of claim 11 further comprising computer-readable instructions for logging, by the password manager, in an audit log, an identification of data associated with a request for access to the first credential by the first user.
